(19) United States
(12) Patent Application Publication
(10) Pub. No.: US 2022/0172257 A1
(43) Pub. Date: Jun. 2, 2022

(54) SYSTEM AND METHOD FOR SALES FORECASTING AND OPTIMAL PATH TO OPPORTUNITY CLOSURE USING SIGNALS FROM MAILBOX ACTIVITY AND CONVERSATIONAL DATA

(71) Applicant: Aviso, Inc., Redwood City, CA (US)

(72) Inventors: Joy MUSTAFI, Hyderabad (IN); Sayan Deb KUNDU, Kolkata (IN); Ravindra KUMAR, BULANDSHAHR (IN); Trevor RODRIGUES, Scottsdale, AZ (US)

(73) Assignee: Aviso, Inc., Redwood City, CA (US)

(21) Appl. No.: 17/110,064

(22) Filed: Dec. 2, 2020

(51) Int. Cl. G06Q 30/02; G06N 20/00

(52) U.S. Cl. CPC G06Q 30/0281; G06N 20/00; G06Q 30/0204

(57) ABSTRACT

A system (100) for sales forecasting and optimal path to opportunity closure. The system (100) including an enterprise internal database (110), external database (108), a server computer (104), and a sales-representative device (112). The enterprise internal database (110) further includes a customer relationship management database (102). The external database (108) stores all data related to buyers social profile and buyer professional profile. The server computer (104) includes a system processor (106), and a system server memory (120). The system processor (106) extracts data from the customer relationship management database (102), the external database (108), the enterprise internal database (110), to automatically calculate engagement score, buyer segmentation, and further the system processor (106) uses engagement score, buyer segmentation to recommends the best buyer to contact. Herein, the system processor (106) trained machine learning model to suggest conversation content to sales representative to optimize the sale closure cycle, thus accelerating deal-cycle.

### FIELD OF INVENTION

The present invention relates to a system and method for sales forecasting and optimal path to opportunity closure, and more specifically relates to a system and method for sales forecasting and optimal path to opportunity closure using signals from mailbox activity and conversational data.

Multiple companies have been operating in the same field nowadays. Thus there is huge competition in the market. The companies have to Even with a slight delay in making the decision, results in loss of the sales deals. If there is a large company, then it is also difficult to make a decision quickly. Some it is difficult to find under performance of sales representative and factor affecting sales representative performance. Thus ultimately the sales target of a particular sales representative does not achieve. To manage customer and sales, there is a CRM system.

But there is huge data in CRM. Most CRMs are not updated regularly because that needs to be updated manually. A company with huge sales data is difficult to update the data regularly. Thus that also delays sales decisions that results in slow sale-cycle because sales representative depends on CRM for decision making. Also, the sales representative unable to find best per to contact that can increase the chance of closing deals faster. Sometimes content of conversation is important to close the deal.

Patent application US2016019661A1 discloses a relationship management system includes a relationship management server system that identifies an objective with respect to an entity defined by a customer relationship management (CRM) service, identifies a first set of contacts associated with the objective, aggregates event information associated with the first set of contacts, scores the objective based upon event information associated with the first set of contacts to generate at least one engagement score, and provides recommendation data to the CRM service from which a task is created within the CRM service associated with at least one contact in the first set of contacts based upon the at least one engagement score.

The existing invention does not give the optimal path of seller-buyer engagement to accelerate the deal cycle. The existing invention does not provide detailed suggestions related to sales. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a system for sales forecasting and optimal path to opportunity closure using signals from mailbox activity and conversational data. The system includes an enterprise internal database, external database, a server computer, and a sales-representative device. The enterprise internal database stores all data related to the company operations management, communication events between sales representative and buyers. The enterprise internal database further includes a customer relationship management database. The customer relationship management database stores all data of related to events that occurs in sale-cycle of current open deals and historical deals. The external database stores all data related to buyers social profile and buyer professional profile. The server computer includes a system processor, and a system server memory. The system processor executes computer-readable instructions to automatically calculate engagement score, buyer segmentation, and further the system processor uses engagement score, buyer segmentation to recommends the best buyer to contact. The system processor uses the trained machine learning model to suggest conversation content to sales representative to optimize the sale closure cycle, thus accelerating deal-cycle. The system server memory stores computer-readable instructions and machine learning model. The sales-representative device is connected to the server computer; the sales representative receives recommendation and suggestion to accelerate the deal-cycle on the sales-representative device. Herein, the customer relationship management database, the external database, the enterprise internal database are all connected to the server computer.

In the preferred embodiment, the system processor extracts data from the customer relationship management database, the external database, the enterprise internal database, to automatically calculate engagement score, buyer segmentation, and further the system processor uses engagement score, buyer segmentation to recommends the best buyer to contact. Herein, the system processor trained machine learning model to suggest conversation content to sales representative to optimize the sale closure cycle, thus accelerating deal-cycle.

The main advantage of the present invention is that the present invention provides a statistically verifiable solution which has yielded positive results.

Yet another advantage of the present invention is that the present invention provides optimal path to opportunity closure using signals from mailbox activity and conversational data.

Yet another advantage of the present invention is that the present invention provides the suggested content to make the communications impactful which makes the deals moving faster.

Yet another advantage of the present invention is that the present invention recommends the best buyer to contact to accelerate the deal.

Further objectives, advantages, and features of the present invention will become apparent from the detailed description provided hereinbelow, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the system of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; 13 and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

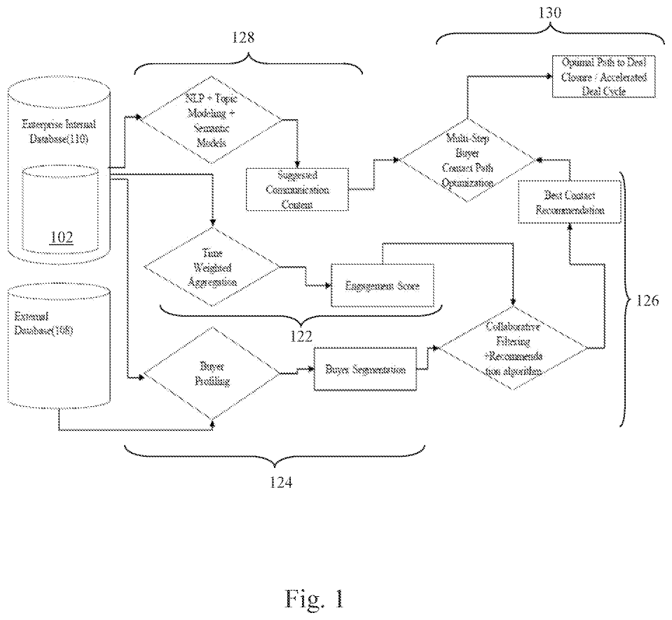

FIG. 1 illustrates flowchart for a method for sales forecasting and optimal path to opportunity closure using signals from mailbox activity and conversational data. In step (122), A method of calculating engagement score having: A system processor (106) of a server computer (104), executes computer-readable instructions and retrieves data related to communication events between sales representative and buyers, from an enterprise internal database (110).The system processor (106) of the server computer (104), executes computer-readable instructions to categorize communication events into four classes, that are email sent by sales representative, email received by sales representative, meeting scheduled by sales representative and meeting scheduled by buyers. The communication events are given scores based on the classes of the events, wherein these score are calculated based on the inverse frequency of the events. For a given communication event, sales representative-buyer relationships are formed for all sales representatives and buyers participated in that event and relationship engagement score is same as the communication event scores for all those sales representatives-buyer relationships. The score of each communication event decays over time, with a half-life. Sales representative engagement score is calculated by summing up all the relationships engagement scores for the given sales representative. Buyer engagement score is calculated by summing up all the relationships engagement scores for the given buyer. Thus deal engagement score is calculated by summing up all the relationships engagement scores for the given deal. In the preferred embodiment, the system processor (106) executes computer-readable instruction that uses the time weight aggregation method to calculate the engagement score. In step (124), a method for buyers segmentation, having: The system processor (106) of the server computer (104), executes computer-readable instructions and retrieves data related to buyers social profile and buyer professional profile from an external database (108). The system processor (106) also retrieves communication events between sales representative and buyers, from the customer relationship management database (102) of the enterprise internal database (110). The system processor (106) executes computer-readable instructions to create buyer overall profile. Then buyer are segmented into different categories, based on buyer overall profile. In step (126), a method for best contact recommendation, having: The system processor (106) of the server computer (104), executes computer-readable instructions that takes buyer engagement score, buyer overall profile and other external factors to predict best buyer to contact. Based on the prediction the system processor (106) recommends best buyer to contact. In the preferred embodiment, the system processor (106) uses collaborative and content based filtering and recommendation algorithm to predict best buyer to contact. In step (128), a method of suggesting conversation content to sales representative while conversing with buyers, having: The system processor (106) of the server computer (104), executes computer-readable instructions and retrieves data related to conversation between sales representative and buyers, from the enterprise internal database (110). Further, the system processor (106) executes computer-readable instruction to integrate all the data and feed the data into a machine learning model. Thus the machine learning model learns from the data. The system processor (106) of the server computer (104) executes computer-readable instructions and identifies important keyword and topic for conversation by using machine learning model. The system processor (106) of the server computer (104) executes computer-readable instructions and recommends content and tone of conversation between sales representative and buyers by using machine learning model. In step (130), a method of accelerating deal-cycle, having: once the sales representative knows the engagement scores for all the buyers, they can concentrate on the right set buyers to close the deal sooner. Buyer segmentation helps the sales representative to communicate to right buyers on right time that cuts down a lot of unnecessary communication. The sales representative uses the suggested content and tone of conversation to make the communications impactful that makes the deals moving faster.

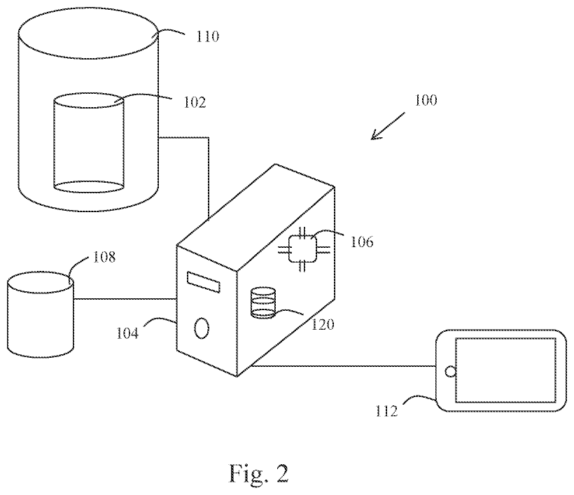

FIG. 2 illustrates a system (100) for sales forecasting and optimal path to opportunity closure using signals from mailbox activity and conversational data. The system (100) including an enterprise internal database (110), external database (108), a server computer (104), and a sales-representative device (112). The enterprise internal database (110) further includes a customer relationship management database (102). The server computer (104) includes a system processor (106), and a system server memory (120

The present invention relates to a method for sales forecasting and optimal path to opportunity closure using signals from mailbox activity and conversational data, the method includes:

A method of calculating engagement score, the method having
a system processor of a server computer, executes computer-readable instructions and retrieves data related to communication events between sales representative and buyers, from an enterprise internal database;
the system processor of the server computer, executes computer-readable instructions to categorize communication events into four classes, that are email sent by sales representative, email received by sales representative, meeting scheduled by sales representative and meeting scheduled by buyers;
communication events are given scores based on the classes of the events, wherein these score are calculated based on the inverse frequency of the events.
for a given communication event, sales representative-buyer relationships are formed for all sales representatives and buyers participated in that event and relationship engagement score is same as the communication event scores for all those sales representatives-buyer relationships;
the score of each communication event decays over time, with a half-life;
sales representative engagement score is calculated by summing up all the relationships engagement scores for the given sales representative;
buyer engagement score is calculated by summing up all the relationships engagement scores for the given buyer; and
thus deal engagement score is calculated by summing up all the relationships engagement scores for the given deal.

In the preferred embodiment, the system processor executes computer-readable instruction that uses the time weight aggregation method to calculate the engagement score.

A method for buyers segmentation, the method having
the system processor of the server computer, executes computer-readable instructions and retrieves data related to buyers social profile and buyer professional profile from an external database, and the system processor also retrieves communication events between sales representative and buyers, from the customer relationship management database of the enterprise internal database; and
the system processor executes computer-readable instructions to create buyer overall profile, and
then buyer are segmented into different categories, based on buyer overall profile.
In the preferred embodiment, the system processor retrieves data related to buyers' social profile and buyer professional profile from the external database that is the social network database from where data is being retrieved.

In the preferred embodiment, overall profile of buyer is created based on fuzzy logic that uses titles and signatures of the buyers as input. Herein, NLP based approach is used when title and signature data is missing.

A method for best contact recommendation, the method having,
the system processor of the server computer, executes computer-readable instructions that takes buyer engagement score, buyer overall profile and other external factors to predict best buyer to contact; and
based on the prediction the system processor recommends best buyer to contact.

In the preferred embodiment, the system processor uses collaborative and content based filtering and recommendation algorithm to predict best buyer to contact.

A method of suggesting conversation content to sales representative while conversing with buyers, the method having
the system processor of the server computer, executes computer-readable instructions and retrieves data related to conversation between sales representative and buyers, from the enterprise internal database,
further, the system processor executes computer-readable instruction to integrate all the data and feed the data into a machine learning model;
thus the machine learning model learns from the data;
the system processor of the server computer, executes computer-readable instructions and identifies important keyword and topic for conversation by using machine learning model; and
the system processor of the server computer executes computer-readable instructions and recommends content and tone of conversation between sales representative and buyers by using machine learning model.

In an embodiment, data that are being extracted from an enterprise internal database to calculate engagement score and to suggest conversation content are including, but not limited to, email, chat and call recordings of sales representative with buyers.

A method of accelerating deal-cycle, the method having
once the sales representative know the engagement scores for all the buyers, they can concentrate on the right set buyers to close the deal sooner;
buyer segmentation helps the sales representative to communicate to right buyers on right time that cuts down a lot of unnecessary communication; and
the sales representative uses the recommended content and tone of conversation to make the communications impactful that makes the deals moving faster.
Herein, the trained machine learning model generates recommendations based on analyses of various information related to the current opportunity and past opportunity, and conversation history between the sales representative and buyers.

In an embodiment, the present invention relates to a method for sales forecasting and optimal path to opportunity closure using signals from mailbox activity and conversational data, the method includes:

A method of calculating engagement score, the method having
one or more system processors of a server computer, execute computer-readable instructions and retrieve data related to communication events between sales representative and buyers, from an enterprise internal database;
one or more system processors of a server computer, execute computer-readable instructions to categorize communication events into four classes, that are email sent by sales representative, email received by sales representative, meeting scheduled by sales representative and meeting scheduled by buyers;
communication events are given scores based on the classes of the events, wherein these score are calculated based on the inverse frequency of the events.
for a given communication event, sales representative-buyer relationships are formed for all sales representatives and buyers participated in that event and relationship engagement score is same as the communication event scores for all those sales representatives-buyer relationships;
the score of each communication event decays over time, with a half-life;
sales representative engagement score is calculated by summing up all the relationships engagement scores for the given sales representative;
buyer engagement score is calculated by summing up all the relationships engagement scores for the given buyer; and
thus deal engagement score is calculated by summing up all the relationships engagement scores for the given deal.

In the preferred embodiment, the one or more system processors execute computer-readable instruction that uses the time weight aggregation method to calculate the engagement score.

A method for buyers segmentation, the method having
the one or more system processors of the server computer, execute computer-readable instructions and retrieve data related to buyers social profile and buyer professional profile from one or more external databases, and the one or more system processors also retrieve communication events between sales representative and buyers, from the customer relationship management database of the enterprise internal database; and
the one or more system processors execute computer-readable instructions to create buyer overall profile, and
then buyer are segmented into different categories, based on buyer overall profile.

In the preferred embodiment, the one or more system processors retrieve data related to buyers' social profile and buyer professional profile from the one or more external databases that is the social network database from where data is being retrieved.

In the preferred embodiment, overall profile of buyer is created based on fuzzy logic that uses titles and signatures of the buyers as input. Herein, NLP based approach is used when title and signature data is missing.

A method for best contact recommendation, the method having,
the one or more system processors of the server computer, execute computer-readable instructions that takes buyer engagement score, buyer overall profile and other external factors to predict best buyer to contact; and
based on the prediction the one or more system processors recommends best buyer to contact.

In the preferred embodiment, the one or more system processors uses collaborative and content based filtering and recommendation algorithm to predict best buyer to contact.

A method of suggesting conversation content to sales representative while conversing with buyers, the method having
the one or more system processors of the server computer, execute computer-readable instructions and retrieve data related to conversation between sales representative and buyers, from the enterprise internal database,
further, the one or more system processors execute computer-readable instruction to integrate all the data and teed the data into a machine learning model;
thus the machine learning model learns from the data;
the one or more system processors of the server computer, execute computer-readable instructions and identifies important keyword and topic for conversation by using machine learning model; and
the one or more system processors of the server computer execute computer-readable instructions and suggests content and tone of conversation between sales representative and buyers by using machine learning model.

In an embodiment, data that are being extracted from an enterprise internal database to calculate engagement score and to recommend conversation content are including, but not limited to, email, chat and call recordings of sales representative with buyers.

A method of accelerating deal-cycle, the method having
once the sales representative know the engagement scores for all the buyers, they can concentrate on the right set buyers to close the deal sooner;
buyer segmentation helps the sales representative to communicate to right buyers on right time that cuts down a lot of unnecessary communication; and
the sales representative uses the suggested content and tone of conversation to make the communications impactful that makes the deals moving faster.

Herein, the trained machine learning model generates suggestions based on analyses of various information related to the current opportunity and past opportunity, and conversation history between the sales representative and buyers.

In the preferred embodiment, all the contact recommendation, conversation content that is being sent to the sales representative on one or more sales-representative devices that include, but not limited to, a desktop computer, a laptop, a tablet, a smartphone, a mobile phone.

In an embodiment, the present invention relates to a system for sales forecasting and optimal path to opportunity closure using signals from mailbox activity and conversational data. The system includes an enterprise internal database, external database, a server computer, and a sales-representative device The enterprise internal database stores all data related to the company operations management, communication events between sales representative and buyers. The enterprise internal database further includes a customer relationship management database. The customer relationship management database stores all data of related to events that occurs in sale-cycle of current open deals and historical deals. The external database stores all data related to buyers social profile and buyer professional profile. The server computer includes a system processor, and a system server memory. The system processor executes computer-readable instructions to automatically calculate engagement score, buyer segmentation, and further the system processor uses engagement score, buyer segmentation to recommends the best buyer to contact. The system processor uses the trained machine learning model to suggest conversation content to sales representative to optimize the sale closure cycle, thus accelerating deal-cycle. The system server memory stores computer-readable instructions and machine learning model. The sales-representative device is connected to the server computer; the sales representative receives recommendation and recommendation to accelerate the deal-cycle on the sales-representative device. Herein, the customer relationship management database, the external database, the enterprise internal database are all connected to the server computer.

In the preferred embodiment, the system processor extracts data from the customer relationship management database, the external database, the enterprise internal database, to automatically calculate engagement score, buyer segmentation, and further the system processor uses engagement score, buyer segmentation to recommends the best buyer to contact. Herein, the system processor trained machine learning model to suggest conversation content to sales representative to optimize the sale closure cycle, thus accelerating deal-cycle.

In an embodiment, the present invention relates to a system for sales forecasting and optimal path to opportunity closure using signals from mailbox activity and conversational data. The system includes an enterprise internal database, one or more external databases, a server computer, and one or more sales-representative devices. The enterprise internal database stores all data related to the company operations management, communication events between sales representative and buyers. The enterprise internal database further includes a customer relationship management database. The customer relationship management database stores all data of related to events that occurs in sale-cycle of current open deals and historical deals. The one or more external databases stores all data related to buyers social profile and buyer professional profile. The server computer includes one or more system processors, and a system server memory. The one or more system processors execute computer-readable instructions to automatically calculate engagement score, buyer segmentation, and further the one or more system processors use engagement score, buyer segmentation to recommend the best buyer to contact. The one or more system processors use the trained machine learning model to suggest conversation content to sales representative to optimize the sale closure cycle, thus accelerating deal-cycle. The system server memory stores computer-readable instructions and machine learning model. The one or more sales-representative devices are connected to the server computer; the sales representative receives recommendation and suggestion to accelerate the deal-cycle on the one or more sales-representative devices. Herein, the customer relationship management database, the one or more external databases, the enterprise internal database are all connected to the server computer.

In the preferred embodiment, the one or more system processors extract data from the customer relationship management database, the one or more external databases, the enterprise internal database, to automatically calculate engagement score, buyer segmentation, and further the one or more system processors use engagement score, buyer segmentation to recommends the best buyer to contact. Herein, the one or more system processors train machine learning model to suggest conversation content to sales representative to optimize the sale closure cycle, thus accelerating deal-cycle.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A method for sales forecasting and optimal path to opportunity closure using signals from mailbox activity and conversational data, the method comprising:
a method of calculating engagement score, the method having
an at least one system processor (106) of a server computer (104), executes computer-readable instructions and retrieves data related to communication events between sales representative and buyers, from an enterprise internal database (110)
an at least one system processor (106) of a server computer (104), executes computer-readable instructions to categorize communication events into four classes, that are email sent by sales representative, email received by sales representative, meeting scheduled by sales representative and meeting scheduled by buyers.
communication events are given scores based on the classes of the events, wherein these score are calculated based on the inverse frequency of the events.
for a given communication event, sales representative-buyer relationships are formed for all sales representatives and buyers participated in that event and relationship engagement score is same as the communication event scores for all those sales representatives-buyer relationships.
the score of each communication event decays over time, with a half-life,
sales representative engagement score is calculated by summing up all the relationships engagement scores for the given sales representative
buyer engagement score is calculated by summing up all the relationships engagement scores for the given buyer.
thus deal engagement score is calculated by summing up all the relationships engagement scores for the given deal
a method for buyers segmentation, the method having
the at least one system processor (106) of the server computer (104), executes computer-readable instructions and retrieves data related to buyers social profile and buyer professional profile from the at least one external database (108), and the at least one system processor (106) also retrieves communication events between sales representative and buyers, from the customer relationship management database (102) of the enterprise internal database (110) and,
the at least one system processor (106) executes computer-readable instructions to create buyer overall profile, and
then buyer are segmented into different categories, based on buyer overall profile;
a method for best contact recommendation, the method having,
the at least one system processor (106) of the server computer (104), executes computer-readable instructions that takes buyer engagement score, buyer overall profile and other external factors to predict best buyer to contact, and
based on the prediction the at least one system processor (106) recommends best person to contact;
a method suggest conversation content to sales representative while conversing with buyers, the method having
the at least one system processor (106) of the server computer (104), executes computer-readable instructions and retrieves data related to conversation between sales representative and buyers, from the enterprise internal database (110),
further, the at least one system processor (106) executes computer-readable instruction to integrate all the data and feed the data into a machine learning model,
thus the machine learning model learns from the data,
the at least one system processor (106) of the server computer (104), executes computer-readable instructions and identifies important keyword and topic for conversation by using machine learning model, and
the at least one system processor (106) of the server computer (104), executes computer-readable instructions and recommends content and tone of conversation between sales representative and buyers by using machine learning model;
a method of accelerating deal-cycle, the method having
once the sales representative know the engagement scores for all the buyers, they can concentrate on the right set buyers to close the deal sooner,
buyer segmentation helps the sales representative to communicate to right buyers on right time that cuts down a lot of unnecessary communication,
the sales representative uses the recommended content and tone of conversation to make the communications impactful that makes the deals moving faster.
wherein the trained machine learning model generates recommendations based on analyses of various information related to the current opportunity and past opportunity, and conversation history between the sales representative and buyers.

2. The method as claimed in claim 1, wherein, data that are being extracted from an enterprise internal database (110) to calculate engagement score and to suggest conversation content are selected from, but not limited to, email, chat and call recordings of sales representative with buyers.

3. The method of calculating engagement score as claimed in claim I, wherein, the at least one system processor (106) executes computer-readable instruction that uses the time weight aggregation method to calculate the engagement score.

4. The method as claimed in claim 1, wherein, the at least one system processor (106) retrieves data related to buyers social profile and buyer professional profile from the at least one external database (108) that is the social network database from where data is being retrieved.

5. The method for buyers segmentation as claimed in claim 1, wherein, overall profile of buyer is created based on fuzzy logic that uses titles and signatures of the buyers as input, wherein, NLP based approach is used when title and signature data is missing,

6. The method for best contact recommendation as claimed in claim 1, wherein, the at least one system processor (106) uses collaborative and content based filtering and recommendation algorithm to predict best buyer to contact.

7. The method as claimed in claim 1, wherein, all the contact recommendation, conversation content that is being sent to the sales representative are sent on an at least one sales-representative device (112) that is selected from a desktop computer, a laptop, a tablet, a smartphone, a mobile phone.

8. A system (100) for sales forecasting and optimal path to opportunity closure using signals from mailbox activity and conversational data, the system (100) comprising:
an enterprise internal database (110), the enterprise internal database (110) stores all data related to the company operations management, communication events between sales representative and buyers, the enterprise internal database (110), having
a customer relationship management database (102), the customer relationship management database (102) stores all data of related to events that occurs in sale-cycle of current open deals and historical deals;
at least one external database (108), the at least one external database (108) stores all data related to buyers social profile and buyer professional profile;
a server computer (104), the server computer (104) having
an at least one system processor (106), the at least one system processor (106) executes computer-readable instructions to automatically calculates engagement score, buyer segmentation, and further the at least one system processor (106) uses engagement score, buyer segmentation to recommends the best buyer to contact, wherein, the at least one system processor (1 06) uses the trained machine learning model to suggest conversation content to sales representative to optimize the sale closure cycle, thus accelerating deal-cycle, and
the system server memory (120), the system server memory (120) stores computer-readable instructions and machine learning model; and
an at least one sales-representative device (112), the at least one sales-representative device (112) is connected to the server computer (104), the sales representative receives recommendation and recommendation to accelerate the deal-cycle on the at least one sales-representative device (116);
wherein, the customer relationship management database (102), the at least one external database (108), the enterprise internal database (110) are all connected to the server computer (104).

9. The at least one system processor (106) as claimed in claim 9, wherein, the at least one system processor (106) extracts data from the customer relationship management database (102), the at least one external database (108), the enterprise internal database (110), to automatically calculates Engagement Score, Buyer Segmentation, and further the at least one system processor (106) uses Engagement Score, Buyer Segmentation to recommends the best buyer to contact, wherein, the at least one system processor (106) trained machine learning model to suggest conversation content to sales representative to optimize the sale closure cycle, thus accelerating deal-cycle.
